(19) United States
(12) Patent Application Publication
(10) Pub. No.: US 2024/0408490 A1
(43) Pub. Date: Dec. 12, 2024

(54) NON-TRANSITORY COMPUTER-READABLE STORAGE MEDIUM HAVING GAME PROGRAM STORED THEREIN, GAME PROCESSING METHOD, AND GAME SYSTEM

(71) Applicant: NINTENDO CO., LTD., Kyoto (JP)

(72) Inventors: Shiro MOURI, Kyoto (JP); Masanobu SATO, Kyoto (JP)

(21) Appl. No.: 18/620,306

(22) Filed: Mar. 28, 2024

(30) Foreign Application Priority Data
Jun. 6, 2023 (JP) 2023-093485

(51) Int. Cl. A63F 13/55

(52) U.S. Cl. CPC A63F 13/55

(57) ABSTRACT

An second object is moved in a course including a first object in accordance with an operation by a player. A plurality of types of third objects in the course is controlled in first behavior preset for each course. In accordance with the second object acting on the first object, the third objects are controlled in second behavior preset for each course. Then, in accordance with the second object acting on a fourth object, any one type of the third objects controlled in the second behavior are controlled in the first behavior.

### CROSS REFERENCE TO RELATED APPLICATION

This application claims priority to Japanese Patent Application No. 2023-093485 filed on Jun. 6, 2023, the entire contents of which are incorporated herein by reference.

### FIELD

The present disclosure relates to processing of an action game having a plurality of courses each including at least one goal.

### BACKGROUND AND SUMMARY

Hitherto, a goal-clearing type action game in which a player character is treated as having cleared a course by reaching a preset goal point, has been disclosed.

In the above action game, a plurality of courses can be prepared. By giving each course a unique feature, it is possible to create entertainment characteristics based on various changes between courses. On the other hand, there is room for improvement in manner of making changes within a single course.

In order to attain the object described above, for example, the following configuration examples are exemplified.

### (Configuration 1)

Configuration 1 is directed to a non-transitory computer-readable storage medium having stored therein a game program for causing at least one processor of a game system to:
execute an action game having a plurality of courses each including at least one goal and a first object;
move a second object in the course in accordance with an operation by a player;
control a plurality of types of third objects in the course in first behavior preset for each course;
control any one type of the third objects in second behavior preset for each course in accordance with the second object acting on the first object;
cause a fourth object to appear in the course in accordance with the second object acting on the first object; and
control any one type of the third objects controlled in the second behavior, in the first behavior in accordance with the second object acting on the fourth object.

According to the above configuration, since a change in the object in the course is caused in the process of advancing from the start to the goal in the course, the entertainment characteristics of the game can be improved. In addition, in any course, a change is caused when the operation character acts on the common first object, and this change is different depending on the course, which makes is difficult for the player to predict what will happen, so that the entertainment characteristics of the game can be further improved. Moreover, since the state that has been changed as a result of acquiring the second object ends and returns to the original state again, new unprecedented entertainment characteristics can be provided as if there were a start and a goal of another course between the start and the goal of the original course.

### (Configuration 2)

In Configuration 2 based on Configuration 1, the plurality of types of third objects may include one or more types of third objects for which the first behavior and the second behavior are set so as to be different and one or more types of third objects for which the first behavior and the second behavior are set so as to be the same.

According to the above configuration, since the content of the second behavior and whether or not the behavior changes from the first behavior to the second behavior can be set individually for each course while using common third objects within or between courses, change contents completely different for each course can be provided to the player.

### (Configuration 3)

In Configuration 3 based on Configuration 1 or 2, the game program may further cause the at least one processor to: change the second object from a first state to a second state in accordance with the second object acting on the first object in at least one course of the plurality of courses; and return the second object from the second state to the first state in accordance with the second object acting on the fourth object.

According to the above configuration, a change may be caused for the second object to be operated by the player. Therefore, a sense of elation of the player as to what kind of change will occur and the entertainment characteristics of the game can be improved.

### (Configuration 4)

In Configuration 4 based on any one of Configurations 1 to 3, the game program may further cause the at least one processor to: control a virtual camera controlled with a first camera control parameter preset for each course, with a second camera control parameter preset for each course, in accordance with the second object acting on the first object in at least one course of the plurality of courses; and control the virtual camera controlled with the second camera control parameter, with the first camera control parameter in accordance with the second object acting on the fourth object.

According to the above configuration, along with change from control in the first behavior to control in the second behavior, the way the screen is displayed and the appearance of the screen can also be changed. Accordingly, the entertainment characteristics of the game can be improved.

### (Configuration 5)

In Configuration 5 based on any one of Configurations 1 to 4, the game program may further cause the at least one processor to: display a predetermined effect on a game screen, regardless of the course, in accordance with the second object acting on the first object; and terminate the display of the predetermined effect in accordance with the second object acting on the fourth object.

According to the above configuration, the player is allowed to recognize that the third object is controlled by second control. Specifically, since the player does not know what kind of second behavior will occur for each course, there is a possibility that the player cannot grasp whether or not change to the second behavior has actually already occurred. In this regard, by displaying the above effect, the player is allowed to recognize that change to the second behavior has occurred.

### (Configuration 6)

In Configuration 6 based on any one of Configurations 1 to 5, the game program may further cause the at least one processor to, in at least one course of the plurality of courses, if the second object acts on the fourth object after acting on the first object, control any one type of the third objects controlled in the second behavior, in the first behavior without changing a position of the second object when the fourth object is acted on.

According to the above configuration, the change for the course after the second object acts on the first object can be enjoyed, and also, for example, when the fourth object is acted on after advancing in the course that is being changed, the state of the course, etc., when no change is caused can be enjoyed.

### (Configuration 7)

In Configuration 7 based on any one of Configurations 1 to 6, the game system may be capable of a multiplayer game by a plurality of players using the same display unit on a single game system, and the game program may further cause the at least one processor to, when a second object operated by a first player of the plurality of players acts on the first object, gather all second objects including the second object operated by the first player, at a predetermined position.

According to the above configuration, when a plurality of players play a multiplayer game, it is possible to suppress occurrence of a situation in which, depending on the positions of the second objects other than the second object operated by the first player, for example, a specific second object cannot advance further due to the content of the second behavior, thereby making it impossible for play of the course to proceed.

### (Configuration 8)

In Configuration 8 based on Configuration 7, the game program may further cause the at least one processor to, when the second object operated by the first player is changed from a first state to a second state in accordance with the second object, operated by the first player, acting on the first object, change all the second objects including the second object operated by the first player to the second state.

According to the above configuration, for example, if, in the course, there is a route that is premised on that the second object is controlled in the second state, it is possible to suppress occurrence of a situation in which a specific second object cannot advance in the course.

### (Configuration 9)

In Configuration 9 based on Configuration 7 or 8, the game program may further cause the at least one processor to, if any second object acts on the fourth object after the second object operated by the first player acts on the first object, control any one type of the third objects controlled in the second behavior, in the first behavior without changing a position of each second object when the fourth object is acted on.

According to the above configuration, the second objects other than the second object that has acted on the fourth object may be disadvantaged by the third object returning to the first behavior, so that the entertainment characteristics of the game can be improved. In addition, the player can be motivated to cause the second object, which is operated by the player, to act on the fourth object as quickly as possible.

### (Configuration 10)

In Configuration 10 based on any one of Configurations 1 to 9, the game program may further cause the at least one processor to give a predetermined reward to the player in accordance with the second object acting on the fourth object.

According to the above configuration, the player can be motivated to cause the second object to act on the first object and act on the fourth object.

### (Configuration 11)

In Configuration 11 based on Configuration 10, a total number of the rewards may be a finite number, and the game program may further cause the at least one processor to give the reward when the course is cleared.

According to the above configuration, the player can acquire a reward when the player clears the course by reaching the goal, and the player can acquire more rewards whose number is finite, when reaching the goal after causing the second object to act on the fourth object. Accordingly, the player can be motivated to cause the second object to act on the first object and act on the fourth object.

### (Configuration 12)

In Configuration 12 based on Configuration 1, the plurality of courses may include a course having a plurality of goals including at least a first goal that can be reached by the second object without causing the second object to act on the first object, and a second goal that requires the second object to act on the first object in order for the second object to reach the second goal.

According to the above configuration, the player can be motivated to play again the course that has been cleared once.

### (Configuration 13)

In Configuration 13 based on any one of Configurations 10 to 12, the game program may further cause the at least one processor to, after the reward is given in accordance with the second object acting on the fourth object, if play of the course is restarted on the basis of the second object coming into a state where the goal cannot be reached, restart the play from a predetermined point in the course in a state where the reward is given.

According to the above configuration, after a reward is given in accordance with acting on the fourth object, even if the player makes a mistake and restarts before clearing the course, the time and effort to acquire the reward again can be omitted, so that the convenience of the player can be improved.

According to the present disclosure, by changing the behavior of even objects of the same type in the course in the process of advancing from the start to the goal in the course, the nature of the game in one course can be diversified, so that the entertainment characteristics of the game can be improved.

### BRIEF DESCRIPTION OF THE DRAWINGS

FIG. 1 is a block diagram showing a non-limiting example of the hardware configuration of a game system 1;

FIG. 2 illustrates a non-limiting example of a game screen;

FIG. 3 illustrates a non-limiting example of the game screen;

FIG. 4 illustrates a non-limiting example of the game screen;

FIG. 5 illustrates a non-limiting example of the game screen;

FIG. 6 illustrates a non-limiting example of the game screen;

FIG. 7 illustrates a memory map showing a non-limiting example of various kinds of data stored in a storage section 32 of a game apparatus 3;

FIG. 8 shows a non-limiting example of the data structure of a course data set 307;

FIG. 9 shows a non-limiting example of the data structure of in-course object data 313;

FIG. 10 is a non-limiting example flowchart showing the details of course play processing executed by the game apparatus 3;

FIG. 11 is a non-limiting example flowchart showing the details of normal state game processing;

FIG. 12 is a non-limiting example flowchart showing the details of special state game processing; and

FIG. 13 is a non-limiting example flowchart showing the details of the special state game processing.

### DETAILED DESCRIPTION OF NON-LIMITING EXAMPLE EMBODIMENTS

### [Hardware Configuration of Game System]

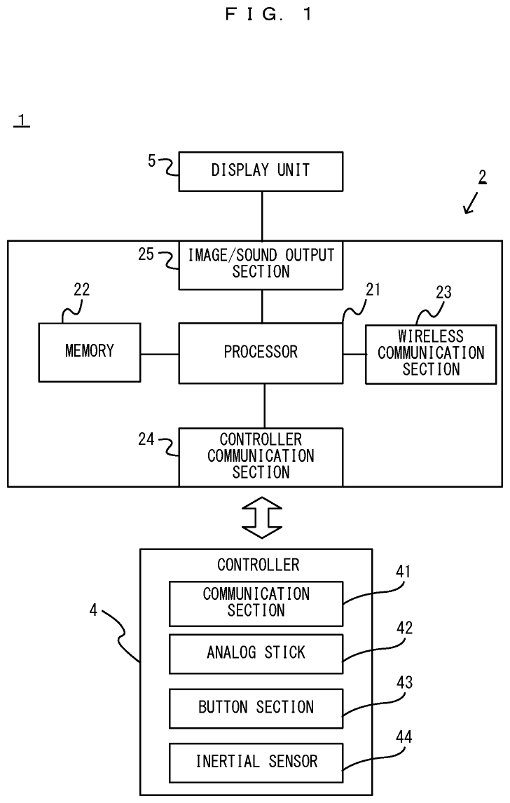

Hereinafter, a game system according to one example of an exemplary embodiment will be described. FIG. 1 is a block diagram showing an example of the hardware configuration of a game system 1 according to the exemplary embodiment. The game system 1 according to the exemplary embodiment includes a game apparatus 3, a controller 4, and a display unit 5. In the exemplary embodiment, the case where the game apparatus 3 is a stationary game apparatus will be described as an example. In another exemplary embodiment, the game apparatus 3 may be an information processing apparatus such as a handheld game apparatus, a smart phone, a tablet terminal, a mobile phone, a personal computer, and a wearable terminal.

In FIG. 1, the game apparatus 3 includes a processor 31. The processor 31 is an information processing section for executing various types of information processing to be executed by the game apparatus 3. For example, the processor 31 may be composed only of a CPU (Central Processing Unit), or may be composed of a SoC (System-on-a-chip) having a plurality of functions such as a CPU function and a GPU (Graphics Processing Unit) function. The processor 31 performs the various types of information processing by executing an information processing program (e.g., a game program) stored in a storage section 32. The storage section 32 may be, for example, an internal storage medium such as a flash memory and a dynamic random access memory (DRAM), or may be configured to utilize an external storage medium mounted to a slot that is not shown, or the like.

The game apparatus 3 also includes a wireless communication section 33 for the game apparatus 3 to perform wireless communication with another game apparatus 3 or a predetermined server. As this wireless communication, for example, internet communication or short-range wireless communication is used.

The game apparatus 3 also includes a controller communication section 34 for the game apparatus 3 to perform wired or wireless communication with a controller 4.

Moreover, a display unit 5 (for example, a television or the like) is connected to the game apparatus 3 via an image/sound output section 35. The processor 31 outputs an image and sound generated (for example, by executing the above information processing) to the display unit 5 via the image/sound output section 35.

Next, the controller 4 will be described. The controller 4 includes at least one analog stick 42 which is an example of a direction input device. The analog stick 42 can be used as a direction input section with which a direction can be inputted. By tilting the analog stick 42, a player is allowed to input a direction corresponding to the tilt direction (also input a magnitude corresponding to the tilt angle). In addition, the controller 4 includes a button section 43 including various operation buttons. For example, the controller 4 may include a plurality of operation buttons on a main surface of the housing.

Moreover, the controller 4 includes an inertial sensor 44. Specifically, the controller 4 includes an acceleration sensor and an angular velocity sensor as the inertial sensor 44. In the exemplary embodiment, the acceleration sensor detects the magnitudes of accelerations along predetermined three axial directions. In addition, the angular velocity sensor detects angular velocities about predetermined three axes.

The controller 4 also includes a communication section 41 for performing wired or wireless communication with the controller communication section 34. The content of a direction input to the analog stick 42, information indicating the press state of the button section 43, and various detection results by the inertial sensor 44 are repeatedly outputted to the communication section 41 and transmitted to the game apparatus 3 at appropriate timings.

### Outline of Information Processing in the Exemplary Embodiment

Next, an outline of information processing according to the exemplary embodiment will be described. In the exemplary embodiment, a description will be given assuming processing of a game played by a player operating a player character object (hereinafter referred to as player character) that exists in a virtual space, as an example of the information processing. More specifically, in the exemplary embodiment, a description will be given assuming a side-scrolling type action game (hereinafter referred to as “this game”). In this game, a virtual space called a “course” which is a main stage of play is prepared. This course may also be called a “stage”, a “round”, etc., depending on the game. A plurality of such courses are prepared. For each course, a start point and a goal point are set. This game is a game for the purpose of having the player character reach the goal point in each course.

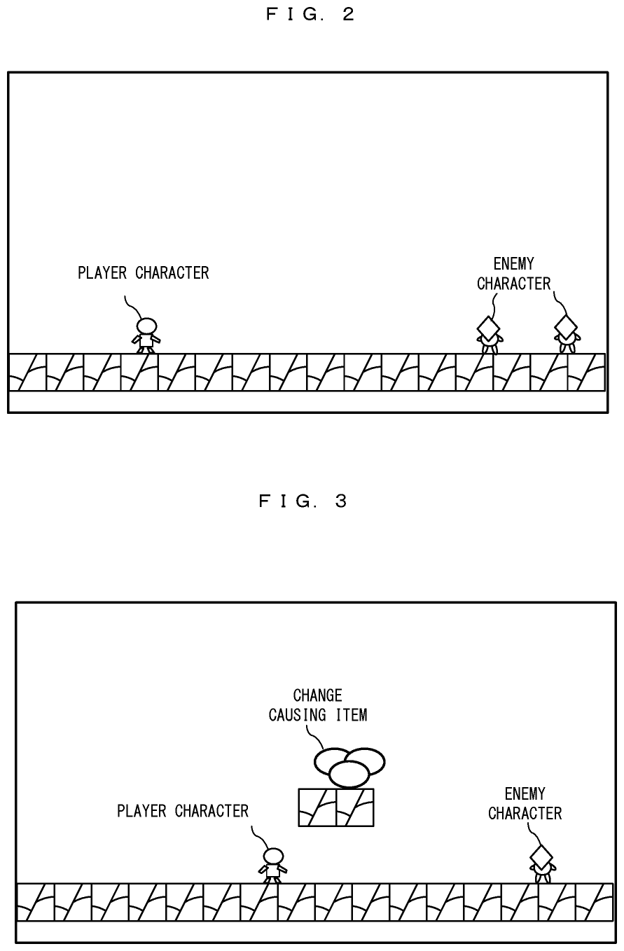

FIG. 2 shows an example of a game screen during play of the above course. In the example of FIG. 2, a part of the course, which is configured as a virtual space that is horizontally long as a whole, is displayed. FIG. 2 also shows an example of a screen near the start point of the course, that is, an example of a screen immediately after the start of play of the course. In this course, the start point is set near the left end of the course, and the goal point is set near the right end of the course. Therefore, as overall game progress, the course is configured such that the player character advances toward the right direction of the screen. In such a game screen, the player operates the player character to move the player character toward the goal point. As the player character moves, another location in the course is displayed. When the player character reaches the goal point, the course is cleared. The player may be allowed to freely select a course to play from among the plurality of courses, or may be allowed to play another course as a result of clearing a certain course.

In addition, various in-course objects are placed between the start point and the goal point. Hereinafter, an example of the in-course objects will be described.

In this example, enemy characters are placed in the course. The enemy characters are objects controlled by the processor 31, and are character objects that act autonomously to some extent and can give damage when the player character comes into contact therewith. For example, the enemy characters move within a predetermined range in the course on the basis of a predefined behavior pattern, or attack when the player character approaches the enemy characters. The enemy characters may also be able to be damaged by a predetermined attack performed by the player character, or may be caused to disappear when the amount of damage exceeds a certain value. Here, as for the enemy characters, various types of enemy characters having different character designs and behavior patterns can appear. In the following description, a group of enemy characters having the same design and controlled in the same behavior pattern is treated as the same “type” of enemy characters. For example, there is “enemy character A” having a behavior pattern of rushing and attacking the player character and “enemy character B” having a behavior pattern of shooting fireballs toward the player character, and a plurality of enemy characters A and a plurality of enemy characters B can appear simultaneously.

In this example, course part objects are placed in the course. The course part objects are each an object that defines a route for the player character in the course or supports or hinders the advancement of the player character when the player character rides the object or collides against the object. The course part objects may be fixed in the course, may move in a predetermined movement pattern, or may move by being acted on by the player character. The course part objects may exist at all times, or may disappear, etc., when predetermined conditions are satisfied. Examples of the course part objects include blocks, trees, sand, snow, platforms, etc. Other examples of the course part objects include a ladder or rope that the player character can ascend or descend. In addition, the course part objects may have some kind of gimmick. For example, when a course part object is acted on by the player character, another course part object may be caused to appear or move. When a course part object is acted on by the player character, the course part object makes the player character move faster or jump higher. As in the case of the enemy characters, course part objects having the same behavior are treated as the same “type”.

The existence of such in-course objects requires the player to operate the player character to reach the goal while defeating, avoiding, or utilizing these various in-course objects.

As described above, when the player character reaches the goal point, the course is cleared. In this game, a course that has been cleared once can be played repeatedly, and the first time the course is cleared, a “reward item” is given to the player as a reward for clearing the course for the first time. The more such reward items the player owns, the more advantageous it is for the player to cause the game to progress. For example, as a precondition for playing a certain course, a condition that the number of owned reward items is a predetermined number or more may be set. In addition, for example, an effect that the performance of the player character is improved as the number of owned reward items increases, may be obtained. From such a viewpoint, one of the purposes of this game is to collect such reward items by clearing more courses.

Meanwhile, in this game, in each course, only one item object called a “change causing item” appears. By causing the player character to act on the change causing item, a course change causing condition is satisfied to bring the currently played course into a state where various changes are caused. This action is, for example, to cause the player character to come into contact with the change causing item. Another example of this action is, for example, when the player throws an item and the item comes into contact with the change causing item. Still another example of this action is, for example, when the change causing item is hidden in an item box, and the change causing item is caused to appear by impacting the item box. After a change is caused as described above, when a change cancellation condition described later is satisfied, the caused change is cancelled to return the course to the original state. The content of the change is set for each course. That is, the change to be caused is different for each course. As for the content of the change, for example, at least one of the following three types of changes is caused. As a matter of course, two or more changes can be caused simultaneously.
(A) Change in the behavior of an enemy character
(B) Change in the behavior of a course part object
(C) Change related to the player character

The above examples of changes are merely examples, and other changes may be caused.

In the following description, the state of the course where the change by the change causing item is being caused is referred to as “special state”. On the other hand, the state of the course where the change by the change causing item is not being caused is referred to as “normal state”. Here, in this game, the behavior of the in-course objects, the behavior of the player character, etc., can change between the “normal state” and the “special state”, but the basic terrain of the course and the basic layout of the course itself remain unchanged. As a result of the change in the behavior of the in-course object in the “special state”, the game nature may be significantly different from that in the “normal state”. Therefore, it is possible to provide the player with a different game experience while using the same course.

As for a game screen in the “special state”, a predetermined screen effect may be added in order to indicate that the current state is the “special state” rather than the “normal state”. For example, as an example of the screen effect, the color may be changed in the entire game screen or in a partial region of the game screen, or an effect image may be superimposed thereon. As another example of the screen effect, the background color of the course may be expressed in colors different between the “normal state” and the “special state”. Accordingly, it is made easier for the player to recognize that the current state is the “special state” rather than the “normal state”. However, the screen effect is not essential, and in another exemplary embodiment, the above screen effect may not necessarily be added in the “special state”.

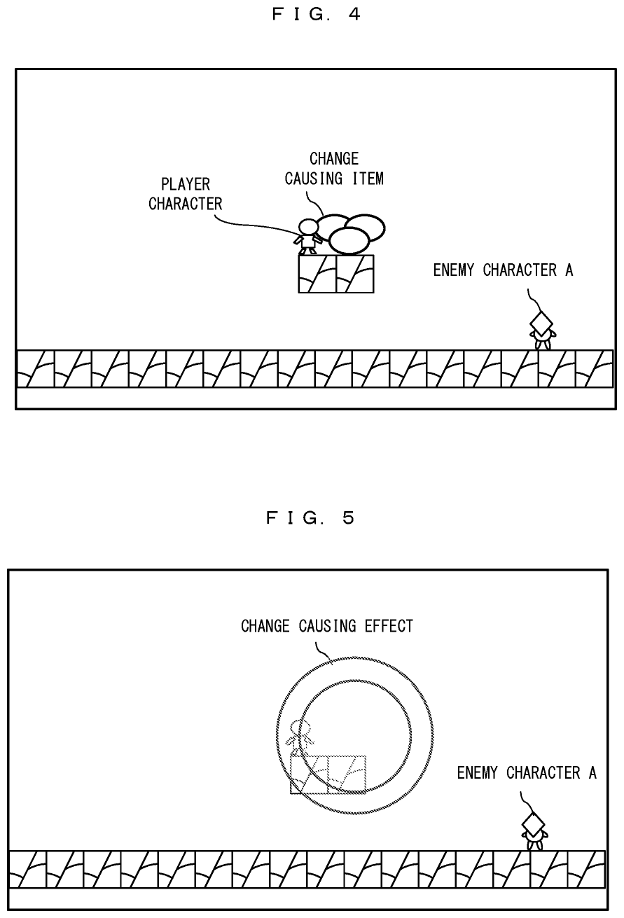

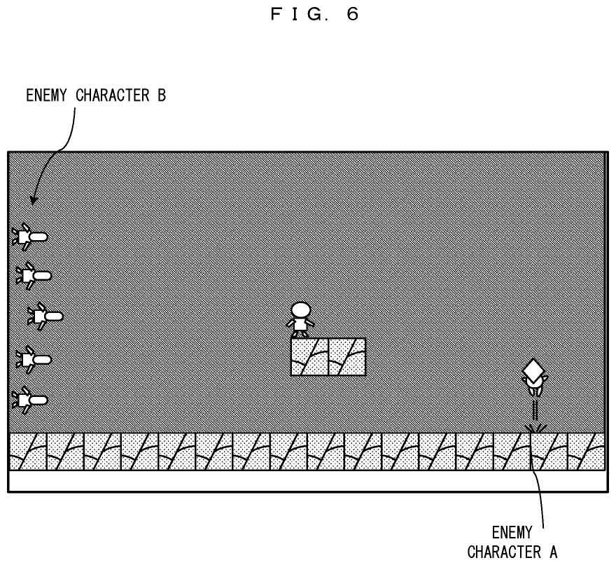

FIG. 3 to FIG. 6 show an example of a screen when the state is changed from the “normal state” to the “special state”. FIG. 3 shows a game screen in the “normal state”. In FIG. 3, a change causing item is displayed. When the player character is moved from the state in FIG. 3 and brought into contact with the change causing item as shown in FIG. 4, the change causing item is deleted, and a change causing effect is displayed as shown in FIG. 5. The change causing effect is, for example, an effect that a circle expands around the position of the change causing item. Then, a game screen in the “special state” is displayed as shown in FIG. 6. In this screen, the background and the ground are expressed in colors different from those in the “normal state”. FIG. 6 also shows an example in which a change in the behavior of an enemy character is caused by the change causing item. First, FIG. 6 shows a state where an enemy character A is jumping. This is an example in which the behavior of the enemy character A in which the enemy character A “does not jump” in the normal state has changed to behavior of “jumping” as a result of change to the special state. Furthermore, FIG. 6 also shows that enemy characters B that have not been displayed in the “normal state” have appeared near the left edge of the screen. This shows an example in which the behavior of the enemy characters B has changed from behavior of “not appearing” to behavior of “appearing”. From another perspective, it can be said that the behavior of the enemy characters B has changed from behavior of “not displayed and not subjected to collision detection” to behavior of “being displayed and being subjected to collision detection”. Since the content of the change to be caused is different for each course as described above, when a change causing item is acquired in another course, another change can be caused. In addition, the manner in which the display form to indicate the “special state” can also differ from course to course. Moreover, the “special state” continues until the change cancellation condition described later is satisfied.

Here, some examples of changes to be caused in the above “special state” will be described.

### Examples of Changes in Behavior of Enemy Characters

First, examples of changes in the behavior of enemy characters are shown below. In this game, for example, the following changes in the behavior of enemy characters can be caused in the “special state”. First, there is a change in which an enemy character that does not appear in the “normal state” appears. That is, the behavior of a certain enemy character changes from behavior of not appearing in the “normal state” to behavior of appearing in the “special state”. For example, when the “special state” is caused, a change in which an enemy character that does not appear in the “normal state” and cannot be defeated by the player character appears at the left edge of the screen and chases the player character, may be caused. In this case, if the player character is caught up by the enemy character, it becomes a “mistake”. Accordingly, the player can enjoy playing with the game nature in which the game proceeds in the “special state” while the player character is running away from the enemy character. As an example, an enemy character that appears in the “normal state” may be caused to disappear in the “special state”, and such an enemy character that is a giant version of this enemy character may be caused to appear in the “special state”. By so doing, the player can be made to feel as if the enemy character that has been in the course in the “normal state” has become a giant in the “special state”

As for the same enemy character, the behavior pattern may change between the “normal state” and the “special state”. For example, the enemy character may move in both the “normal state” and the “special state”, but the pattern of movement may change only in the “special state”. As an example, the movement speed may increase, the range of movement may increase, etc. For example, the pattern of attack may change only in the “special state”. As an example, an enemy character that attacks by spraying water in the “normal state” may attack by breathing fire in the “special state”, or may attack more frequently in the “special state” than in the “normal state”.

For example, it is assumed that there are a plurality of enemy characters A, and some of the enemy characters A are defeated in the normal state. In this case, when the special state is caused afterwards, the behavior of only the remaining enemy characters A that have not been defeated may change.

### Examples of Changes in Behavior of Course Part Objects

Next, some examples of changes in the behavior of the course part objects are shown. Basically, as in the case of the above enemy characters, there is a change in which a course part object that does not appear in the “normal state” appears. For example, when the “special state” is caused, a change in which an iron ball object (a type of course part object) rolls from the left edge of the screen, may be caused. Also, for example, when the “special state” is caused, a change in which “walls” that have not appeared in the “normal state” appear at a predetermined position to obstruct the advancement route of the player character or create a maze-like course, may be caused. Also, for example, a cannon object that does not particularly move in the “normal state” is placed, and a change in which cannonballs are fired from this cannon object may be caused only in the “special state”. Accordingly, the difficulty level of the game may be increased in the “special state”. In addition, a tree that does not move in the “normal state” and serves as a platform may move only in the “special state”. Accordingly, a certain area in the course may be able to be reached only in the “special state” by riding the moving tree and moving.

As in the case of the above enemy characters, the appearance or behavior pattern of a course part object that also appears in the “normal state” may be changed. For example, a block that temporarily protrudes a short platform when acted on by the player character in the “normal state” may be placed, and a long platform may be automatically protruded from the block only in the “special state”.

In the exemplary embodiment, the behavior of the above change causing item in the “special state” cannot be set, but may be settable. That is, the change causing item may be treated, for example, as an object that appears in the “normal state” (until the player character comes into contact therewith) and does not appear in the “special state”.

For example, it is assumed that, as course part objects, there are objects that can be destroyed and objects that can be moved. In this case, an object that is destroyed or moved in the normal state may be made to take over a state that is the state in the normal state, even when the special state is caused afterwards. That is, a destroyed object may remain destroyed, and a moved object may remain unchanged in position even after the special state is caused.

### Examples of Changes Related to Player Character

Next, an example of change related to the player character is shown. In this example, the state (appearance, performance, etc.) of the player character may change depending on the course. For example, a change in which the size of the player character is increased and collision detection is increased accordingly, may be caused.

The method of controlling the movement of the player character may also be changed. For example, the player character may be able to move in the air in the “special state”. More specifically, when the “special state” is caused, the movement of the player character may be controlled such that the player character first jumps up high, the screen scrolls upward accordingly, and when the player character reaches the sky, the player character moves as if swimming in the air.

For example, the player character may be changed to be able to move on a damaging floor without being damaged. More specifically, when the “special state” is caused, the state (control content) of the player character may be changed such that the appearance of the player character changes (the player character transforms) and the player character is not damaged even if the player character comes into contact with a damaging floor. In this case, along with the end of the “special state”, the appearance returns to the original appearance, and the state returns to the state of being damaged from the damaging floor.

In the “special state”, a change in which the player character can move faster or jump higher than in the “normal state”, may be caused.

For example, in the “special state”, the player character may be controlled such that the player character can move with the far-side direction of the screen as a downward direction. As an example, the player character may be controlled such that the player character can move on a wall displayed in the far-side direction of the screen as a platform. In this case, the display form of the player character on the display screen may change from a display form in which the entire body is viewed from the side to a display form in which the entire body is viewed from the head top direction. At this time, the control of the player character in the direction of gravity may be actually changed. That is, control may be performed such that gravity is generated in the far-side direction of the screen. In this case, for example, when the player character jumps, the player character is controlled such that the player character falls in the far-side direction after jumping in the near-side direction from the far side of the screen.

The direction of gravity itself is not changed, but the appearance of the player character may be changed to a slime-like appearance, and the movement of the player character may be changed such that the player character can stick to a wall or a ceiling and move thereon.

### Example of Simultaneously Causing Changes in Two or More Types of Objects

As an example of simultaneously causing changes in two or more types of objects, the following changes may be caused. For example, the player character may cause a change in all the player character, the enemy characters, and the course part objects such that the movement thereof becomes slower. That is, a change of decreasing the movement speed of each object or the reproduction speed of an animation may be caused.

For example, when the “special state” is caused, a change in which BGM different from that in the “normal state” is reproduced and the enemy characters and the course part objects move in time with the rhythm of the BGM, may be caused. For example, behavior control may be performed such that the enemy characters jump all at once at a certain timing during the reproduction of the BGM. Furthermore, control of the player character into which the element of a rhythm game is introduced may be performed, for example, it may be possible to score points by causing the player character to jump in time with the rhythm.

### [Changes in Control of Virtual Camera]

The behavior and control method of a virtual camera may also be different between the “normal state” and the “special state” according to the various change contents described above. That is, various parameters for controlling the virtual camera may be different between the “normal state” and the “special state”. For example, in the “normal state”, if the player character moves upward to the outside of the screen by, for example, jumping at the upper edge of the screen, or the like, the virtual camera is not moved to follow the player character (the screen does not scroll in the vertical direction), but in the “special state”, even in such a case, the virtual camera may be caused to follow the movement of the player character (the screen may scroll in the vertical direction), thereby extending the range of movement of the virtual camera. In the “special state”, the virtual camera may be rotated slightly to the left and the display on the screen may be rotated slightly to the right, thereby performing representation as if the virtual world is tilted to the right. In this case, by applying gravity to the player character and the enemy characters slightly rightward (downward on the display screen), it is possible to create an illusion that the virtual world is tilted.

### [End of “Special State”]

Next, the end of the “special state” will be described. In this game, as a change cancellation condition for canceling the “special state” to return to the “normal state”, a condition that the above reward item placed in the course is acquired, is set. More specifically, by coming into contact with the above change causing item, a condition for causing the “special state” is satisfied, and one reward item is placed at a predetermined position in the course in addition to the reward item as a reward for clearing. Then, by bringing the player character into contact with this reward item, a condition for canceling the “special state” is satisfied. This can be said to be a configuration in which another course is included in one course. That is, this other course is a course in which a start point is the position of the change causing item and a goal point is the point at which the reward item is placed as a result of the change to the “special state”. If the “special state” is cancelled, the various changes that have been caused for the in-course objects and the player character are also cancelled, and the state of the course returns to the “normal state”

Along with the cancellation of the “special state”, the above reward item is given to the player. In this regard, in terms of the number of reward items that can be acquired, up to two reward items including one reward for clearing for the first time and one reward that can be acquired in the “special state” can be acquired for each course. The reward item in the “special state” is also given only for the first time. For example, after the reward item in the “special state” is acquired, even if the cleared course is played again, the “special state” is caused, and the “special state” is cancelled, a reward item is not given. If the reward item has already been acquired in the “special state”, the display forms of the change causing item and the reward item may be changed. For example, both the change causing item and the reward item may be displayed semi-transparently to inform the player that the reward item has already been acquired.

In the exemplary embodiment, the reward item in the “special state” may also be treated as a type of course part object. Specifically, the behavior of the reward item may be defined such that the reward item does not appear in the “normal state” but appears in the “special state”.

Here, supplementary description will be given regarding the case where, in an uncleared course, after the reward item is acquired in the “special state”, the remaining number of player characters is decreased due to a “mistake” before reaching the goal. For example, in a state where the remaining number of player characters is three, if a certain course is played and a “mistake” is made after the reward item is acquired in the “special state”, the play is restarted from a predetermined restart point with the remaining number of player characters being decreased to two by one. In this case, the reward item in the “special state” is temporarily treated as “already acquired”. However, if the remaining number of player characters reaches zero without reaching the goal, that is, if the course is not cleared in the end, the reward item acquired in the “special state” is also treated as not having been acquired. In other words, the acquisition of the reward item in the “special state” is confirmed when the course is cleared.

Supplementary description will also be given regarding the placement position of the change causing item. The placement position of the change causing item may basically be any position, but depending on the course, the change causing item may be placed behind the midpoint of the course (e.g., at a point where, by reaching it, the point restart can be possible even if a “mistake” is made later). By placing the change causing item as described above, the player can be allowed to cause the player character to come into contact with the change causing item after playing the course to some extent and grasping the atmosphere of the course (the behavior pattern of each enemy character, existence of various course part objects, etc.). As a result, the player can be surprised by using the play up to that point as a “prelude (preliminary, introduction)”, and exaggerating or completely inverting the atmosphere grasped by the player.

As for the condition for cancelling the “special state”, in addition to contact with the reward item, a condition that a time limit elapses may be used depending on the course. In this case, a time limit counter is also displayed on the game screen along with shifting to the “special state”. Then, if contact with the reward item cannot be performed within the time limit, the “special state” is cancelled at that time. In this case, the reward item cannot be acquired either. That is, the game nature is a game nature having the purpose of coming into contact with the reward item within the time limit. In this case, the change causing item may be set not to appear again, for example, until the course is cleared and exited. On the other hand, if a “mistake” is made in the “special state”, the game may be restarted from the state before the “special state”, and the change causing item may be able to appear again.

Next, the position of the player character when returning from the “special state” to the “normal state” will be described. In the exemplary embodiment, play in the “normal state” is basically restarted in a state where the player character is placed at the position where the “special state” is cancelled (near the placement position of the reward item). That is, the advancement made in the course in the “special state” is reflected when the state returns to the “normal state”. For example, it is assumed that the state is changed to the “special state” at a point A in the course, and the player character advances to a point B in the “special state”. Then, when the “special state” is cancelled at the point B to return to the “normal state”, play in the “normal state” is restarted in a state where the player character is present at the point B. Accordingly, depending on the course, by moving (returning) the player character toward the start point, it is possible to provide the player with an enjoying way to check what the course was like in the “normal state”.

Depending on the course, play in the “normal state” may be restarted after the player character is returned to the position before the start of the “special state”, that is, the position at which the player character comes into contact with the change causing item. For example, if the “special state” is cancelled at the above point B, play in the “normal state” may be restarted after the player character is moved to the above point A.

It is also assumed that when the “special state” is cancelled, there is no object that can serve as a platform at the position of the player character. In this case, the player character falls, and play in the “normal state” is restarted from the point at which the player character lands. For example, the case where a change in which the player character can “swim in the air” has been caused is assumed as the “special state”. In this case, if the “special state” is cancelled when the player character is in the air, the course returns to the “normal state” and then the player character falls. Then, play is restarted from the point of landing.

As described above, in the game of the exemplary embodiment, the state of the course can be changed from the “normal state” to the “special state” by contact with the change causing item placed on the course. Therefore, the player can cause the player character to advance to the goal in the “normal state” without contact with the change causing item, or may enjoy playing with the game nature changed by the “special state” on the way to the goal as a result of contact with the change causing item. Furthermore, as described above, the content of the change in the “special state” is different for each course. Therefore, it is possible to provide the player with various changes, in each course, which can significantly change even the game nature in response to contact with the “same” item which can commonly appear in any course, that is, the change causing item.

Hereinafter, the game processing in the exemplary embodiment will be described in more detail.

### [Data to be Used in Game Processing]

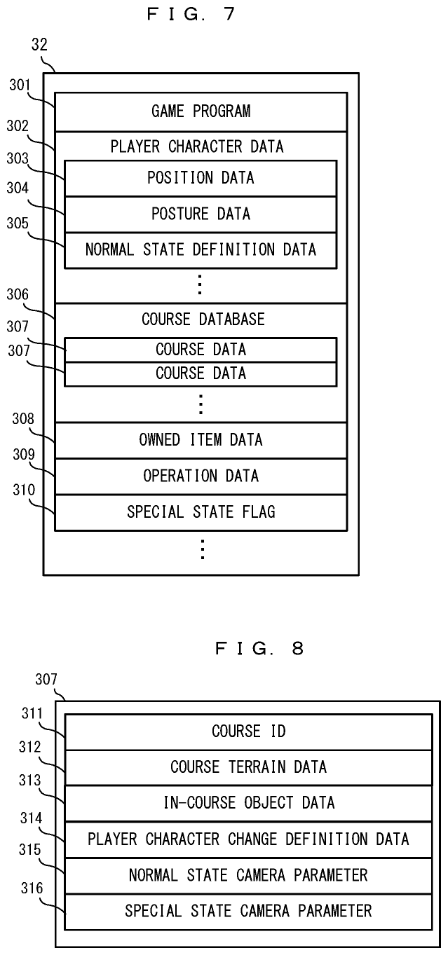

First, data to be used in this game processing will be described. FIG. 7 illustrates a memory map showing an example of various kinds of data stored in the storage section 32 of the game apparatus 3. In the storage section 32, at least a game program 301, player character data 302, a course database 306, owned item data 308, operation data 309, and a special state flag 310 are stored.

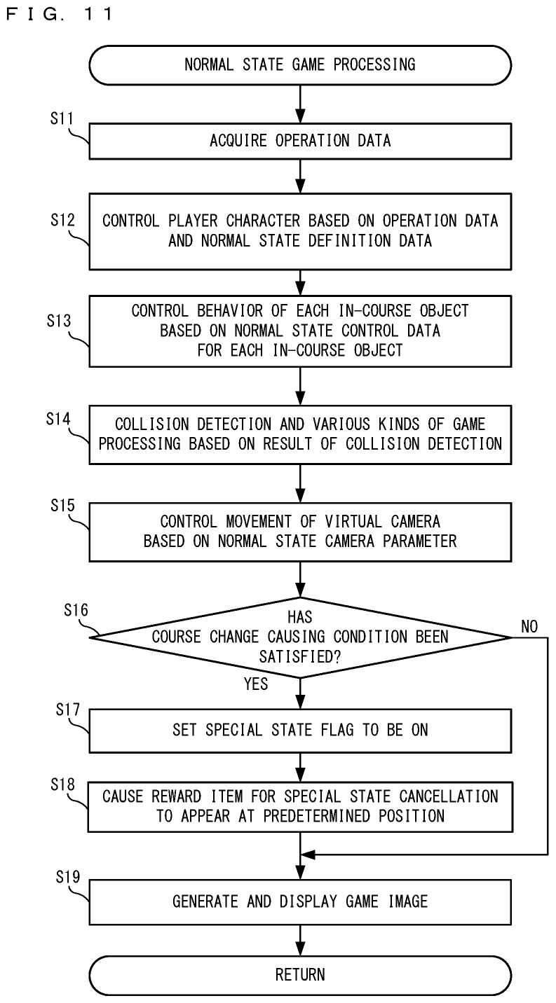

The game program 301 is a program for executing game processing including the course play processing shown in a flowchart in FIG. 10 described later.

The player character data 302 is data regarding the above player character to be operated by the player. The player character data 302 includes position data 303, posture data 304, normal state definition data 305, etc. The position data 303 is data indicating the position of the player character on each course. The posture data 304 is data indicating the posture of the player character. The normal state definition data 305 includes various kinds of data that are common to each course and define the state of the player character in the “normal state”, specifically, the appearance and the content of the behavior based on operations by the player, etc. For example, the normal state definition data 305 includes model data and image data for the appearance in the normal state, data related to the movement speed, data related to the highest point reached when jumping and the fall speed, data defining the shape and size of collision detection, animation data for various actions to be performed by the player character such as jumping, etc.

The course database 306 is a database that defines the contents of the courses described above. The course database 306 includes a plurality of course data sets 307, and one course data set 307 corresponds to one course. FIG. 8 shows an example of the data structure of a course data set 307. The course data set 307 includes at least a course ID 311, course terrain data 312, in-course object data 313, player character change definition data 314, a normal state camera parameter 315, and a special state camera parameter 316.

The course ID 311 is an ID for uniquely identifying each course. The course terrain data 312 is data of the terrain forming each course, and includes polygon mesh data and texture data for the terrain.

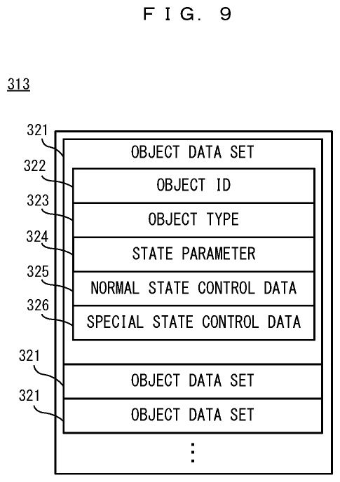

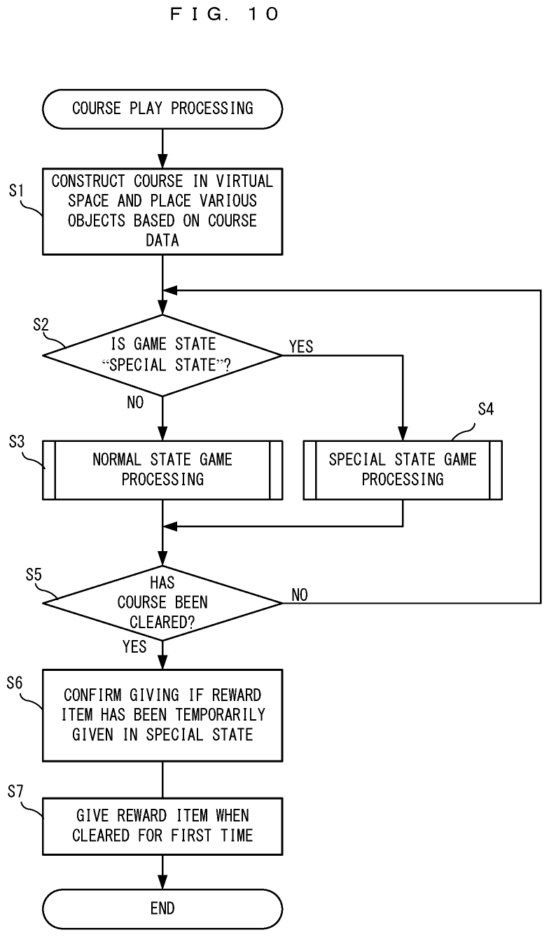

The in-course object data 313 is data that defines each of the above in-course objects that can appear in the course. FIG. 9 shows an example of the data structure of the in-course object data 313. The in-course object data 313 includes a plurality of object data sets 321. Each object data set 321 includes at least an object ID 322, an object type 323, a state parameter 324, normal state control data 325, and special state control data 326.

The object ID 322 is an ID for identifying each object.

The object type 323 is data indicating the type of the object. For example, data such as “enemy character A”, “enemy character B”, “course part object A”, or “course part object B” is set.

The state parameter 324 is a parameter indicating the current state and is used in controlling the behavior of the object. For example, parameters indicating the current position and the current posture are stored. Various parameters indicating the current state of the object, such as moving, attacking, and jumping, are also stored. A parameter indicating whether or not to cause the object to appear on the course is also stored. For example, in the case of an enemy character, the state parameter 324 is a parameter indicating whether the enemy character has been defeated or not, and in the case of a course part object, the state parameter 324 is a parameter indicating whether the course part object has been destroyed or not, acquired or not, etc.

The normal state control data 325 is, for example, data that defines the behavior of the object in the above “normal state”. The special state control data 326 is data that defines the behavior of the object in the above “special state”. Some examples of the definitions of these data are shown below. For example, for a certain enemy character, the normal state control data 325 includes data specifying that the movement speed is 1.0, and the special state control data 326 includes data specifying that the movement speed is 2.0. In another example, for a certain enemy character, the normal state control data 325 includes data specifying “not appearing”, and the special state control data 326 includes data specifying “appearing”. As an example, it is assumed that, for an enemy character object having a certain appearance, the normal state control data 325 includes data specifying “appearing”, and the special state control data 326 includes data specifying “not appearing”, and for an enemy character object having a different appearance (for example, size and detailed shape) from that enemy character, the normal state control data 325 includes data specifying “not appearing”, and the special state control data 326 includes data specifying “appearing”. In this case, as a result of change from the “normal state” to the “special state”, a representation can be performed as if the enemy character that has previously appeared has changed to the enemy character having a different appearance. In another example, for example, for the same course part object, different coloring image data may be specified in the normal state control data 325 and the special state control data 326. In still another example, different color information may be specified as color information for the object in the normal state control data 325 and the special state control data 326. In this case, the color of the in-course object changes as a result of change from the “normal state” to the “special state”

As for the above in-course objects, the same contents are defined as the contents of the normal state control data 325 and the special state control data 326 for objects whose behavior does not change between the “normal state” and the “special state”. In other words, this can be said that for objects whose behavior does not change, a content of “behavior does not change in the special state” is positively defined. Owing to the use of this data structure, by defining behavior different between the “normal state” and the “special state” only in some courses and defining the same behavior in the “normal state” and the “special state” in the other courses while causing the enemy character A to appear in a plurality of courses, settings can be easily made such that the basic data regarding the enemy character A is used but the behavior of the enemy character A is changed in the “special state” only in the some courses.

In the exemplary embodiment, as the behavior defined in the special state control data 326, behavior different for each course is defined. However, this does not exclude the case where the behavior is common to some courses. Also, in the exemplary embodiment, the behavior defined in the special state control data 326 is set for each object type. For example, for objects whose object type 323 is the same, the same content is set. For example, in the case where a plurality of enemy characters whose object type 323 is “enemy character A” are caused to appear, the special state control data 326 for these objects may have the same content. In this regard, for example, in at least some courses, different behavior between the “normal state” and the “special state” may be defined for only some of objects of the same type. Also, for example, in at least some courses, for some objects among objects of the same type for which different behavior between the “normal state” and the “special state” is defined, different behavior in the “special state” from the other objects may be defined.

In the exemplary embodiment, the data structure of having the normal state control data 325 for each course is exemplified. In this regard, in another exemplary embodiment, for example, the data structure may be a data structure that allows data that can be used in common among a plurality of courses, such as data indicating the appearance of the in-course objects in the normal state (model data, texture) and data indicating behavior patterns, to be used in common. Only data that is unique to each course, such as the placement positions of the in-course objects in each course, may be set as the normal state control data 325 for each course.

Referring back to FIG. 8, the player character change definition data 314 is data that defines the content of the change in the player character in the case where the course is in the “special state”, that is, the state of the player character in the special state. For example, in the case where the appearance of the player character is changed, image data of the player character is included. In the case where the size of collision detection or the like is changed, data specifying the size after the change is included. In the case where the control content is changed, the movement speed, the movement pattern, animation data, etc., of the player character are included. In the case of a course in which the player character is not particularly changed between the “normal state” and the “special state”, the same content as the normal state definition data 305 is defined in the player character change definition data 314.

As the content of the change in the player character defined in the player character change definition data 314, a change content that can be caused also in the “normal state” may be defined, or a change content that is not caused in the “normal state” may be defined. For example, it is assumed that there is an item that can appear on the course in the “normal state” and that, when acquired, makes the player character larger. For a certain course, the same effect as when this item is acquired may be defined as the content of the change in the player character in the “special state”. In addition, a change content that cannot be caused in the “normal state”, that is, a change content that is not caused except by contact with the change causing item, may be defined.

The normal state camera parameter 315 is various parameters for controlling the virtual camera in the normal state. For example, initial values of the position, the imaging direction, the angle of view, etc., of the virtual camera in the normal state are defined.

The special state camera parameter 316 is various parameters for controlling the virtual camera in the special state. For example, initial values of the position, the imaging direction, the angle of view, etc., of the virtual camera in the special state are defined. In the case of a course in which the control of the virtual camera is not changed between the “normal state” and the “special state”, the same content as the normal state camera parameter 315 is defined.

Referring back to FIG. 7, the owned item data 308 is data indicating in-game items acquired by the player in this game. The owned item data 308 includes data indicating the number of owned reward items described above, etc.

The operation data 309 is data acquired from the controller 4 operated by the player. That is, the operation data 309 is data indicating the contents of operations performed by the player.

The special state flag 310 is a flag for identifying whether or not the current state of the course is the “special state”. If the special state flag 310 is ON, it indicates that the current state is the “special state”, and if the special state flag 310 is OFF, it indicates that the current state is the “normal state”.

### [Details of Processing Executed by Processor 31 of Game Apparatus 3]

Next, the details of the course play processing in the exemplary embodiment will be described with reference to FIG. 10 to FIG. 13. FIG. 10 is a flowchart showing the details of the course play processing executed by the processor 31 of the game apparatus 3. In the exemplary embodiment, in the game apparatus 3, the processing shown in FIG. 10 is started, for example, when an operation for playing a predetermined course is performed by the player from a course selection screen (not shown). Also, in the exemplary embodiment, flowcharts described below are realized by one or more processors reading and executing the above program stored in one or more memories. The flowcharts described below are merely an example of the processing. Therefore, the order of each process step may be changed as long as the same result is obtained. In addition, the values of variables and thresholds used in determination steps are also merely examples, and other values may be used as necessary.

When the course play processing starts, first, in step S1, the processor 31 reads the course data set 307 corresponding to the course selected by the player. Next, the processor 31 constructs the course in the virtual space by placing various terrain objects on the basis of the course data set 307. Furthermore, the processor 31 places various in-course objects and the above change causing item on the course. Moreover, the processor 31 places the player character at the start point. The processor 31 also places the virtual camera at a predetermined position on the basis of the normal state camera parameter 315. The processor 31 also sets the special state flag 310 to be “OFF”.

Next, in step S2, the processor 31 determines whether or not the special state flag 310 is ON. If, as a result of the determination, the special state flag 310 is OFF, that is, the current state is the “normal state” (NO in step S2), the processor 31 executes normal state game processing in step S3.

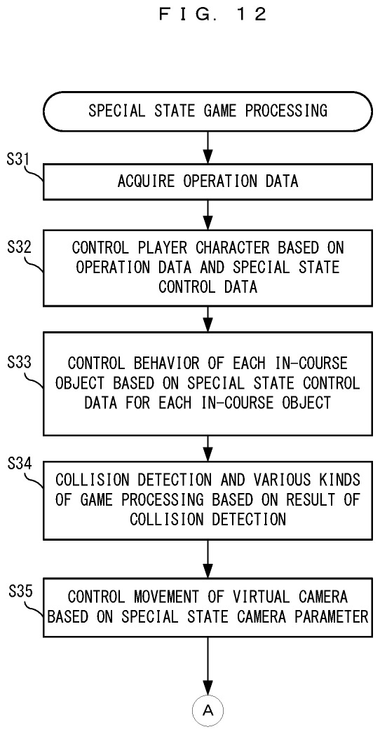

FIG. 11 is a flowchart showing the details of the normal state game processing. In FIG. 11, first, in step S11, the processor 31 acquires the operation data 309. Next, in step S12, the processor 31 controls the player character on the basis of the operation data 309 and the above normal state definition data 305.

Next, in step S13, the processor 31 controls the behavior of each in-course object existing on the course at that time, on the basis of the normal state control data 325 for each object. Accordingly, the various enemy characters and the course part objects are controlled in the behavior in the “normal state”.

Next, in step S14, the processor 31 performs a collision detection (collision determination) process, and performs various kinds of game processing based on the result of this process.

Next, in step S15, the processor 31 performs movement control, etc., of the virtual camera on the basis of the normal state camera parameter 315.

Next, in step S16, the processor 31 determines whether or not a course change causing condition has been satisfied. In the case of this example, the course change causing condition is that the player character comes into contact with the change causing item. In this regard, in another exemplary embodiment, this condition may be, for example, a condition that a hidden change causing item is caused to appear (no contact is required). If, as a result of the determination, the course change causing condition has been satisfied (YES in step S16), in step S17, the processor 31 sets the special state flag 310 to be ON. In addition, the processor 31 determines that the player character has acquired the change causing item, and deletes the change causing item from the course. That is, the processor 31 updates the state parameter 324 such that the change causing item does not exist on the course. At this time, the processor 31 also performs setting regarding rendering for displaying the above change causing effect for a predetermined time. Moreover, at this time, the processor 31 may move the position of the player character to a predetermined position. In particular, in another exemplary embodiment, in the case where the course change causing condition is that a change causing item is caused to appear (no contact is required), the position of the player character is forcibly moved to the position where the change causing item is located, for example. Accordingly, a starting point in the “special state” can be fixed regardless of the position of the player character before the “special state”.

Next, in step S18, the processor 31 causes a reward item, which is also used as a condition for cancelling the special state, to appear at a predetermined position on the course. In this example, this reward item is also treated as one of the above course part objects as described above. Then, the behavior of the reward item is defined such that the reward item does not appear in the “normal state” but appears in the “special state”. Therefore, the reward item is caused to appear by changing the behavior in the same manner as the other in-course objects. In this regard, in another exemplary embodiment, a method of causing a reward item to appear may be a method in which a reward item that has not existed on the course so far is caused to appear by placing the reward item. Then, the processor 31 advances the processing to step S19 described later.

On the other hand, if, as a result of the determination in step S16 above, the course change causing condition has not been satisfied (NO in step S16), the processes in step S17 and S18 above are skipped.

Next, in step S19, the processor 31 generates a game image by using an image of the virtual space taken by the virtual camera, and outputs the game image to the display unit 5. This is the end of the normal state game processing.

Referring back to FIG. 10, next, the case where, as a result of the determination in step S2 above, it is determined that the special state flag is ON (YES in step S2), will be described. In this case, in step S4, the processor 31 executes special state game processing.

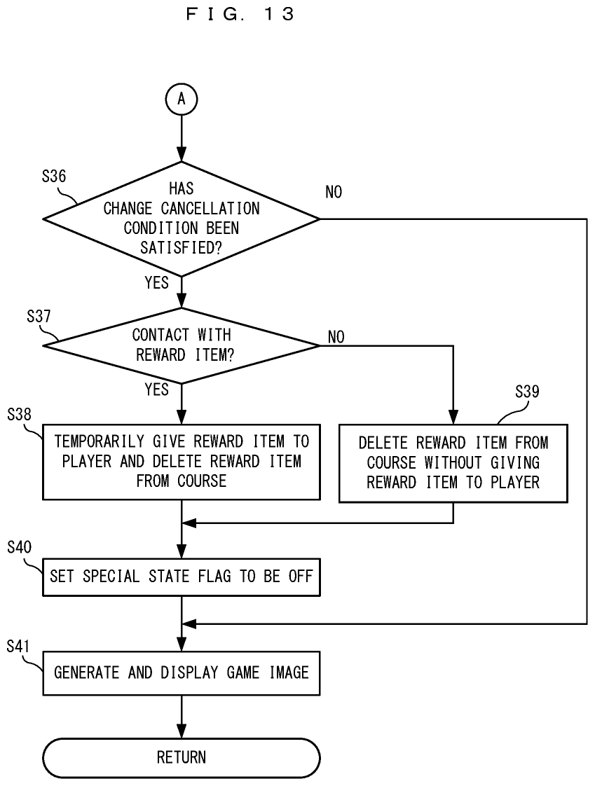

FIG. 12 and FIG. 13 are flowcharts showing the details of the special state game processing. In FIG. 12, first, in step S31, the processor 31 acquires the operation data 309. Next, in step S32, the processor 31 controls the player character on the basis of the operation data 309 and the content defined in the above player character change definition data 314. Accordingly, the player character is controlled on the basis of the content in the “special state”. Therefore, if a content different from that in the “normal state” is defined in the player character change definition data 314, the state of the player character changes from the state in the “normal state”.

Next, in step S33, the processor 31 controls the behavior of each in-course object on the basis of the special state control data 326 for each object. Accordingly, the various enemy characters and the course part objects are controlled in the behavior in the “special state”. In addition, since the special state control data 326 is set for each object type, for example, only the behavior of some types of in-course objects may be changed such that the behavior of the enemy characters A does not change from that in the “normal state” but the behavior of the enemy characters B is different from that in the “normal state”.

Next, in step S34, the processor 31 performs various collision detection processes, and performs various kinds of game processing based on the result of these processes.

Next, in step S35, the processor 31 performs movement control, etc., of the virtual camera on the basis of the special state camera parameter 316.

Next, in step S36 in FIG. 13, the processor 31 determines whether or not a change cancellation condition has been satisfied. In this example, as the change cancellation condition, it is assumed that either one of a condition that the player character comes into contact with the reward item caused to appear in step S18 above and a condition that a predetermined time limit elapses is satisfied. If, as a result of the determination, either one of the above two conditions has been satisfied (YES in step S36), next, in step S37, the processor 31 determines whether or not the change cancellation condition has been satisfied by the player character coming into contact with the reward item. If, as a result of the determination, the change cancellation condition has been satisfied by the player character coming into contact with the reward item (YES in step S37), in step S38, the processor 31 performs a process of temporarily giving the reward item to the player. Then, the processor 31 deletes the reward item from the course.

On the other hand, if the change cancellation condition has been satisfied by the elapse of the time limit without contact with the reward item (NO in step S37), in step S39, the processor 31 deletes the reward item from the course without temporarily giving the reward item to the player.

Next, in step S40, the processor 31 sets the special state flag 310 to be OFF. Along with this, rendering setting may be performed such that a predetermined effect image indicating that the “special state” has been cancelled is displayed for a predetermined time. Then, the processor 31 advances the processing to step S41.

On the other hand, if, as a result of the determination in step S36 above, the change cancellation condition has not been satisfied (NO in step S36), the processes in steps S37 to S40 above are skipped.

Next, in step S41, the processor 31 generates a game image by using an image of the virtual space taken by the virtual camera, and outputs the game image to the display unit 5. At this time, as described above, the course may be rendered using different colors from those in the “normal state”, for the background, the ground, etc. In addition, rendering may be performed with a predetermined screen effect that is not displayed in the “normal state”. Accordingly, a game image with the same terrain as in the “normal state” but a different appearance such as overall coloring can be displayed.

This is the end of the special state game processing.

Referring back to FIG. 10, when the processing in step S3 or S4 ends, next, in step S5, the processor 31 determines whether or not a condition for clearing the currently played course has been satisfied. That is, the processor 31 determines whether or not the player character has reached the goal point. If, as a result of the determination, the player character has not reached the goal point (NO in step S5), the processor 31 returns to step S2 above and repeats the processing. On the other hand, if the condition for clearing the course has been satisfied (YES in step S5), in step S6, the processor 31 confirms giving of the reward item if the reward item has been temporarily given in the “special state”. That is, the processor 31 updates the owned item data 308 such that the number of owned reward items is increased by one.

Next, in step S7, if the current course is cleared for the first time, the processor 31 gives the reward item as a reward for clearing for the first time. That is, the processor 31 updates the owned item data 308 such that the number of owned reward items is increased by one.

This is the end of the course play processing.

As described above, in the exemplary embodiment, the behavior of the in-course object is changed by satisfying the course change causing condition on the way the player character advances from the start point to the goal point, so that the entertainment characteristics of the game can be improved. In addition, the behavior of the in-course object is changed as a result of contact with the change causing item which is an object common to all courses, and the content of the change is different depending on the course. That is, the type of change can be different for each course. For example, there is a conventional game in which, when a switch-type predetermined object is acted on, a predetermined item appears at a predetermined position on a course. The position at which the predetermined item appears can be different for each course, but the content of change itself in which “a predetermined item appears” when the switch object is acted on is the same for all courses. In this regard, in the exemplary embodiment, when a switch object is acted on, a different change can be caused for each course, in addition to “a predetermined item appears”. Therefore, the player can predict that a change will be caused by the change causing item, but cannot predict what kind of change will be caused (at least in the initial play of each course). Accordingly, a sense of expectation and elation as to what will happen can be provided to the player, thereby improving the entertainment characteristics of the game. In addition, by contact with the reward item in the “special state”, the caused change is cancelled, and the state returns to the original state. Therefore, a game experience can be provided as if there were a pseudo start point and goal point of another course in the path of the original course, thereby providing unprecedented entertainment characteristics to the player.

### [Modifications]

In the above embodiment, the example of processing assuming single play has been described. In another exemplary embodiment, the above course play may be realized as a multiplayer game. In this case, as a mode of multiplay, there is a mode in which the game is played using the same screen display when viewed from any player. Specifically, in addition to a mode in which the game is played by a plurality of players using a display screen of one game apparatus, there is a mode in which the same screen is displayed on the game apparatus of each player when the game is played by a plurality of players using a plurality of game apparatuses via communication such as the internet.

In the case of multiplay as described above, in addition to the above control, the following control is further performed. For example, it is assumed that four players perform multiplay. In this case, if the player character of one of the players comes into contact with the above change causing item, the positions of the player characters of the other players are forcibly moved to the position of the change causing item. That is, when the state changes from the “normal state” to the “special state”, play in the “special state” is started from the same point for all four players (the player characters of the four players may overlap each or be in close proximity to each other). This is because, if the “special state” is caused without moving the player characters, there is a possibility that depending on the relationship between the content of the change and the position of each player character, for example, some player characters may be blocked by a newly appearing wall object and be unable to move forward, for example, which may result in unforeseen disadvantages. For this reason, when the state is changed to the “special state”, all the player characters are gathered at the same position. If the “special state” is cancelled, such forced movement is not performed, and play in the “normal state” is restarted from the position of each player character at the time when the “special state” is cancelled. In consideration of the fact that the competitive nature of the game in which players compete to acquire a reward item, which is a condition for cancelling the “special state”, on a first-come basis is provided in the “special state”, forced movement at the time of cancellation of the “special state” is not performed. In this regard, in another exemplary embodiment, when the “special state” is cancelled as well, all the player characters may be forcibly moved to a predetermined position. In the case of single play as well, when the player character comes into contact with the change causing item, the player character may be forcibly moved to a predetermined position.

If the content of the change in the “special state” is to cause a change in the player character, control, in which the same change is caused not only for the player character that has come into contact with the change causing item, but also for all the player characters, is performed. This is to prevent the player characters that have not come into contact with the change causing item from being unable to advance, for example, if the course is a course configured such that a player character cannot advance unless a change in the player character has been caused in the “special state”.

In still another exemplary embodiment, when the “special state” is caused, play in the “special state” may be started without forcibly moving the other player characters as described above. Furthermore, if the content of the change in the “special state” is to cause a change in the player character, a change may be caused only for the player character that has come into contact with the change causing item. In this case, for example, the game development can be that the other player characters temporarily leave the progress of the game to the player character that has come into contact with the change causing item.

As for the configuration of the course, the course may include a route to which the player character can advance only when a predetermined change in the player character is caused by contact with the change causing item. That is, the course may be configured such that the route itself exists in the “normal state”, but in order to advance along this route, a change has to be caused for the player character by contact with the change causing item.

As for the configuration of the course, a course configured as described below may be used. For example, the course may be configured such that the goal can be reached in the special state without acquiring the above reward item. Conversely, the course may be configured such that the goal point cannot be reached without acquiring the above reward item.

For example, the course may be configured such that the course can be cleared without contact with the change causing item. Conversely, the course may be configured such that the player character cannot advance and reach the goal unless the player character comes into contact with the change causing item to change to the special state.

The courses in the game may also include a course having a configuration in which no clear goal point is provided. For example, there may be a course that is considered to have been cleared when a predetermined condition is achieved. In such a course, the above change causing item and reward item may be placed.

Among the courses having a goal point, some courses may be courses in which no change causing item is placed.

In the above embodiment, the case where there is only one goal point in each course has been assumed as an example. In another exemplary embodiment, two goal points may be set for some courses, and a reward item may be able to be acquired at each goal point as a reward for clearing for the first time. In this case, a maximum of three reward items including the reward item in the “special state” can be acquired. In this case, one goal point may be set at a position that can only be reached in the “special state”. That is, the course may be configured such that the condition for cancelling the special state and the condition for clearing the course are satisfied at the same time. With such a course configuration, the course has to be cleared at least twice in order to collect all reward items, and thus the player's motivation to play again the course that has been cleared once can be increased.

In the above embodiment, the case where the number of reward items for each course is a finite number has been described as an example. In another exemplary embodiment, the number of reward items may not necessarily be a finite number. For example, in the case where in-game currency can be collected in the course, a higher amount of in-game currency may be given as the above reward item.

The content of the reward item in the special state and the content of the reward item given by reaching the goal may be different. In this case, the number of reward items of either type may be a finite number for each course.

In another exemplary embodiment, the reward item used as the condition for cancelling the “special state” may not necessarily be caused to appear. In this case, for example, elapse of a time limit may be used as the condition for cancelling the “special state”. Alternatively, reaching a predetermined point may be used as the condition for cancelling the “special state”.

In the above embodiment, the side-scrolling type action game has been described as an example, but the present disclosure is not limited to such a game, and the above processing can be applied to other games. For example, the above game may be a vertically scrolling game. Alternatively, the game may be a game in which a game screen scrolls automatically. Still alternatively, the game may be a game in which a screen is displayed as a 3D screen in a first-person view or third-person view. Still alternatively, the game is not limited to the action game, and may be another genre of game such as a shooting game.

In the above embodiment, the case where a series of processes regarding the game processing are executed in the single game apparatus 3 has been described. In another exemplary embodiment, the series of processes may be executed in an information processing system including a plurality of information processing apparatuses. For example, in an information processing system including a terminal-side apparatus and a server-side apparatus communicable with the terminal-side apparatus via a network, some of the series of processes above may be executed by the server-side apparatus. Further, in an information processing system including a terminal-side apparatus and a server-side apparatus communicable with the terminal-side apparatus via a network, major processes among the series of processes above may be executed by the server-side apparatus, and some of the processes may be executed in the terminal-side apparatus. Further, in the above information processing system, the system on the server side may be implemented by a plurality of information processing apparatuses, and processes that should be executed on the server side may be shared and executed by a plurality of information processing apparatuses. Further, a configuration of so-called cloud gaming may be adopted. For example, a configuration may be adopted in which: the game apparatus 3 sends operation data indicating operations performed by the player to a predetermined server; various game processes are executed in the server; and the execution result is streaming-distributed as a moving image/sound to the game apparatus 3.

While the present disclosure has been described in detail, the foregoing description is in all aspects illustrative and not restrictive. It is to be understood that numerous other modifications and variations can be devised without departing from the scope of the present disclosure.

What is claimed is:

1. A non-transitory computer-readable storage medium having stored therein a game program for causing at least one processor of a game system to:
execute an action game having a plurality of courses each including at least one goal and a first object;
move a second object in the course in accordance with an operation by a player;
control a plurality of types of third objects in the course in first behavior preset for each course;
control any one type of the third objects in second behavior preset for each course in accordance with the second object acting on the first object;
cause a fourth object to appear in the course in accordance with the second object acting on the first object; and
control any one type of the third objects controlled in the second behavior, in the first behavior in accordance with the second object acting on the fourth object.

2. The non-transitory computer-readable storage medium according to claim 1, wherein the plurality of types of third objects include one or more types of third objects for which the first behavior and the second behavior are set so as to be different and one or more types of third objects for which the first behavior and the second behavior are set so as to be the same.

3. The non-transitory computer-readable storage medium according to claim 1, wherein the game program further causes the at least one processor to:
change the second object from a first state to a second state in accordance with the second object acting on the first object in at least one course of the plurality of courses; and
return the second object from the second state to the first state in accordance with the second object acting on the fourth object.

4. The non-transitory computer-readable storage medium according to claim 1, wherein the game program further causes the at least one processor to:
control a virtual camera controlled with a first camera control parameter preset for each course, with a second camera control parameter preset for each course, in accordance with the second object acting on the first object in at least one course of the plurality of courses; and
control the virtual camera controlled with the second camera control parameter, with the first camera control parameter in accordance with the second object acting on the fourth object.

5. The non-transitory computer-readable storage medium according to claim 1, wherein the game program further causes the at least one processor to:
display a predetermined effect on a game screen, regardless of the course, in accordance with the second object acting on the first object; and
terminate the display of the predetermined effect in accordance with the second object acting on the fourth object.

6. The non-transitory computer-readable storage medium according to claim 1, wherein the game program further causes the at least one processor to, in at least one course of the plurality of courses, if the second object acts on the fourth object after acting on the first object, control any one type of the third objects controlled in the second behavior, in the first behavior without changing a position of the second object when the fourth object is acted on.

7. The non-transitory computer-readable storage medium according to claim 1, wherein
the game system is capable of a multiplayer game by a plurality of players using the same display unit on a single game system, and
the game program further causes the at least one processor to, when a second object operated by a first player of the plurality of players acts on the first object, gather all second objects including the second object operated by the first player, at a predetermined position.

8. The non-transitory computer-readable storage medium according to claim 7, wherein the game program further causes the at least one processor to, when the second object operated by the first player is changed from a first state to a second state in accordance with the second object, operated by the first player, acting on the first object, change all the second objects including the second object operated by the first player to the second state.

9. The non-transitory computer-readable storage medium according to claim 7, wherein the game program further causes the at least one processor to, if any second object acts on the fourth object after the second object operated by the first player acts on the first object, control any one type of the third objects controlled in the second behavior, in the first behavior without changing a position of each second object when the fourth object is acted on.

10. The non-transitory computer-readable storage medium according to claim 1, wherein the game program further causes the at least one processor to give a predetermined reward to the player in accordance with the second object acting on the fourth object.

11. The non-transitory computer-readable storage medium according to claim 10, wherein
a total number of the rewards is a finite number, and
the game program further causes the at least one processor to give the reward when the course is cleared.

12. The non-transitory computer-readable storage medium according to claim 1, wherein the plurality of courses include a course having a plurality of goals including at least a first goal that can be reached by the second object without causing the second object to act on the first object, and a second goal that requires the second object to act on the first object in order for the second object to reach the second goal.

13. The non-transitory computer-readable storage medium according to claim 10, wherein the game program further causes the at least one processor to, after the reward is given in accordance with the second object acting on the fourth object, if play of the course is restarted on the basis of the second object coming into a state where the goal cannot be reached, restart the play from a predetermined point in the course in a state where the reward is given.

14. A game processing method executed by at least one processor of a game system, the game processing method causing the at least one processor to:
execute an action game having a plurality of courses each including at least one goal and a first object;
move a second object in the course in accordance with an operation by a player;
control a plurality of types of third objects in the course in first behavior preset for each course;
control any one type of the third objects in second behavior preset for each course in accordance with the second object acting on the first object;
cause a fourth object to appear in the course in accordance with the second object acting on the first object; and
control any one type of the third objects controlled in the second behavior, in the first behavior in accordance with the second object acting on the fourth object.

15. The game processing method according to claim 14, wherein the plurality of types of third objects include one or more types of third objects for which the first behavior and the second behavior are set so as to be different and one or more types of third objects for which the first behavior and the second behavior are set so as to be the same.

16. The game processing method according to claim 14, further causing the at least one processor to:
change the second object from a first state to a second state in accordance with the second object acting on the first object in at least one course of the plurality of courses; and
return the second object from the second state to the first state in accordance with the second object acting on the fourth object.

17. The game processing method according to claim 14, further causing the at least one processor to:
control a virtual camera controlled with a first camera control parameter preset for each course, with a second camera control parameter preset for each course, in accordance with the second object acting on the first object in at least one course of the plurality of courses; and
control the virtual camera controlled with the second camera control parameter, with the first camera control parameter in accordance with the second object acting on the fourth object.

18. The game processing method according to claim 14, further causing the at least one processor to:
display a predetermined effect on a game screen, regardless of the course, in accordance with the second object acting on the first object; and
terminate the display of the predetermined effect in accordance with the second object acting on the fourth object.

19. The game processing method according to claim 14, further causing the at least one processor to, in at least one course of the plurality of courses, if the second object acts on the fourth object after acting on the first object, control any one type of the third objects controlled in the second behavior, in the first behavior without changing a position of the second object when the fourth object is acted on.

20. A processing system comprising at least one processor, the at least one processor being configured to:
execute an action game having a plurality of courses each including at least one goal and a first object;
move a second object in the course in accordance with an operation by a player;
control a plurality of types of third objects in the course in first behavior preset for each course;
control any one type of the third objects in second behavior preset for each course in accordance with the second object acting on the first object;
cause a fourth object to appear in the course in accordance with the second object acting on the first object; and
control any one type of the third objects controlled in the second behavior, in the first behavior in accordance with the second object acting on the fourth object.
